(19) United States
(12) Patent Application Publication
(10) Pub. No.: US 2025/0271538 A1
(43) Pub. Date: Aug. 28, 2025

(54) USER EQUIPMENT-COORDINATION SET JOINT RADAR PROCESSING

(71) Applicant: Google LLC, Mountain View, CA (US)

(72) Inventors: Jibing Wang, San Jose, CA (US); Erik Richard Stauffer, Mountain View, CA (US)

(21) Appl. No.: 19/057,837

(22) Filed: Feb. 19, 2025

Related U.S. Application Data
(60) Provisional application No. 63/559,076, filed on Feb. 28, 2024.

(51) Int. Cl. G01S 7/00; G01S 13/86; H04W 48/08; H04W 92/18

(52) U.S. Cl. CPC G01S 7/006; G01S 13/86; H04W 48/08; H04W 92/18

(57) ABSTRACT

This disclosure provides systems, devices, apparatus, and methods, including computer programs for a UECS. A coordinating UE (102e) receives (216C-216F), from a first UE (102f, 102g), of the UECS, first object detection information for a first radar signal reception. The coordinating UE (102e) obtains (216), from a second UE (102f, 102g) of the UECS, second object detection information for a second radar signal reception associated with a same transmitted radar signal as the first radar signal reception. The second object detection information is different than the first object detection information. The coordinating UE (102e) processes (218), at the coordinating UE (102e), the first object detection information together with the second object detection information to produce joint object detection information. The coordinating UE (102e) jointly transmits (220B), via the UECS, a radar report including joint object detection information of the UECS.

### CROSS-REFERENCE TO RELATED APPLICATIONS

This application claims the benefit of U.S. Provisional Patent Application No. US63/559,076, filed 28 Feb. 2024 the disclosure of which is incorporated herein by reference in its entirety.

### TECHNICAL FIELD

The present disclosure relates generally to wireless communication, and more particularly, to user equipment-coordination set (UECS) for radar processing.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (5G UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, etc.) based on multiple-access technologies, such as orthogonal frequency division multiple access (OFDMA) technologies, that support communication with multiple UEs. Improvements in mobile broadband continue the progression of such wireless communication technologies. For example, bistatic and multi-static radar sensing techniques can improve detection and identification of an object due to increased information about an object. The bistatic and multi-static radar sensing techniques increase a radio cross-section of the object, which increases the information about the object. However, employing a single user equipment (UE) acting as a radar-receiver to perform bistatic and multi-static radar sensing with the radar-transmitter has limitations. For example, the UE might not detect the radar reflection/object accurately because the radar reflection off the object is weak.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

Object detection techniques using monostatic radar configurations that employ full-duplex operations might result in high self-interference from the radar-transmitter to the radar-receiver (e.g., within a same radar transceiver). High self-interference degrades full-duplex operations and negatively impacts radar sensing accuracy. Bistatic or multi-static radar sensing techniques, which employ a radar-transmitter and a radar-receiver at different entities can overcome the above-described limitations of monostatic radar configurations because outgoing transmit (Tx) radar signals of the radar-transmitter do not as easily interfere with receptions of the radar-receiver when the radar-transmitter and the radar-receiver are spatially distanced from each other.

Aspects of the present disclosure address the above-noted and other deficiencies by implementing a joint radar processing technique using a user-equipment-coordination set (UECS) formed by multiple UEs and led by a coordinating UE. The UEs within the UECS cooperatively act as a radar-receiver, and a network entity (or another UE) may act as a radar-transmitter.

Each UE in the UECS transmits, to the coordinating UE, a UE capability message. The coordinating UE selects UE(s) in the UECS to participate in the joint radar processing based on the UE capability message(s). For example, the coordinating UE may select a UE based on a minimum available battery level or a thermal condition, processing power (e.g., maximum or available), memory size, operational frequencies (e.g., supported range or available range), antenna configurations (e.g., supported or available), location (e.g., current location and an accuracy or resolution capability), orthogonal frequency-division multiple access (OFDMA) or orthogonal time frequency space (OTFS) capability, etc.

After the selection of the UEs, the coordinating UE transmits, to a radar-transmitter, a UECS capability message for the UEs in the UECS capable of participating in the joint radar processing. In contrast to the UE capability message, the UECS capability message refers to the capability of all of the UEs within the UECS that are selected for participating in the joint radar processing.

In examples, a network entity acts as a radar-transmitter transmitting a radar signal. In other examples, the radar-transmitter is another UE. In response to the transmitting of the radar signal, one or more of the UEs in the UECS may receive a reflection of a radar signal transmitted by the radar-transmitter, or may receive the radar signal directly without a reflection. Responsive to receiving the radar signal or reflection of the radar signal, the UE(s) transmit, to the coordinating UE via a sidelink communication, in-phase and quadrature (IQ) samples of the radar signal (or reflection of the radar signal) for joint radar processing. To calculate or determine information about a potential object associated with the radar signal reflection, the coordinating UE may use location information of the UEs in the UECS that receive the radar signal or radar signal reflection. The coordinating UE may also use location information of the radar-transmitter to determine the information about the object.

The coordinating UE performs the joint radar processing based on the information received by the coordinating UE and transmits, to the radar-transmitter or other entity separate from the radar-transmitter (e.g., another UE within or outside the UECS), a radar measurement report message including jointly combined object information from the radar signal/reflection measurement(s). In examples, the radar measurement report includes position information, size information, resolution information, and/or movement information. In some examples, one or more UEs in the UECS transmit respective IQ samples of the radar signal (or reflection of the radar signal) for processing at the coordinating UE to reduce the processing load on the other UEs in the UECS. In some other examples, one or more of the UEs in the UECS individually performs the radar processing for the radar measurement report message and provides the processed information to the coordinating UE, which combines the processed information before the coordinating UE transmits the radar measurement report message.

According to some aspects, a coordinating UE receives, from a UE of the UECS, first object detection information for a first radar signal reception. The coordinating UE obtains, from a second UE, second object detection information for a second radar signal reception associated with a same transmitted radar signal as the first radar signal reception. The second object detection information is different than the first object detection information. The coordinating UE processes, at the coordinating UE, the first object detection information together with the second object detection information. The coordinating UE transmits a radar report including joint object detection information of the UECS, the joint object detection information being based on the first object detection information and the second objection detection information.

According to some aspects, a UE transmits, to a coordinating UE, of the UECS, first object detection information for a first radar signal reception. The UE receives, from the coordinating UE, joint object detection information including the first object detection information processed together with second object detection information associated with a same transmitted radar signal as the first radar signal reception, the second object detection information being different than the first object detection information. The UE transmits a radar report including the joint object detection information, the joint object detection information being based on the first object detection and the second objection detection information.

According to some aspects, a radar-transmitter transmits, to a UE in a UECS, control signaling indicating a resource grant for a radar signal and a communication grant for a radar report. The radar-transmitter transmits, via the resource grant, the radar signal between the radar-transmitter and the UE in the UECS. The radar-transmitter receives, from the UE in the UECS via the communication grant, a radar report including joint object detection information of the UECS. The joint object detection information corresponds to the transmitting of the radar signal.

### BRIEF DESCRIPTION OF THE DRAWINGS

FIG. 1A illustrates a diagram of a wireless communications system that includes a plurality of user equipments (UEs) and network entities in communication over one or more cells according to an embodiment.

FIG. 1B is a diagram illustrating an example environment for implementing user equipment-coordination set (UECS) joint radar processing according to an embodiment.

FIG. 2A is a signaling diagram that illustrates procedures for UECS radar processing with the coordinating UE performing joint processing according to an embodiment.

FIG. 2B is a signaling diagram that illustrates procedures for UECS radar processing with the individual UE performs individual processing according to an embodiment.

FIG. 3 is a flowchart of a method of UECS joint processing at a coordinating UE according to an embodiment.

FIG. 4 is a flowchart of a method of UECS joint processing at a non-coordinating UE within the UECS according to an embodiment.

FIG. 5 is a flowchart of a method of UECS joint processing at a radar-transmitter according to an embodiment.

FIG. 6 is a diagram illustrating a hardware implementation for an example UE apparatus according to some embodiments.

FIG. 7 is a diagram illustrating a hardware implementation for one or more example network entities according to some embodiments.

### DETAILED DESCRIPTION

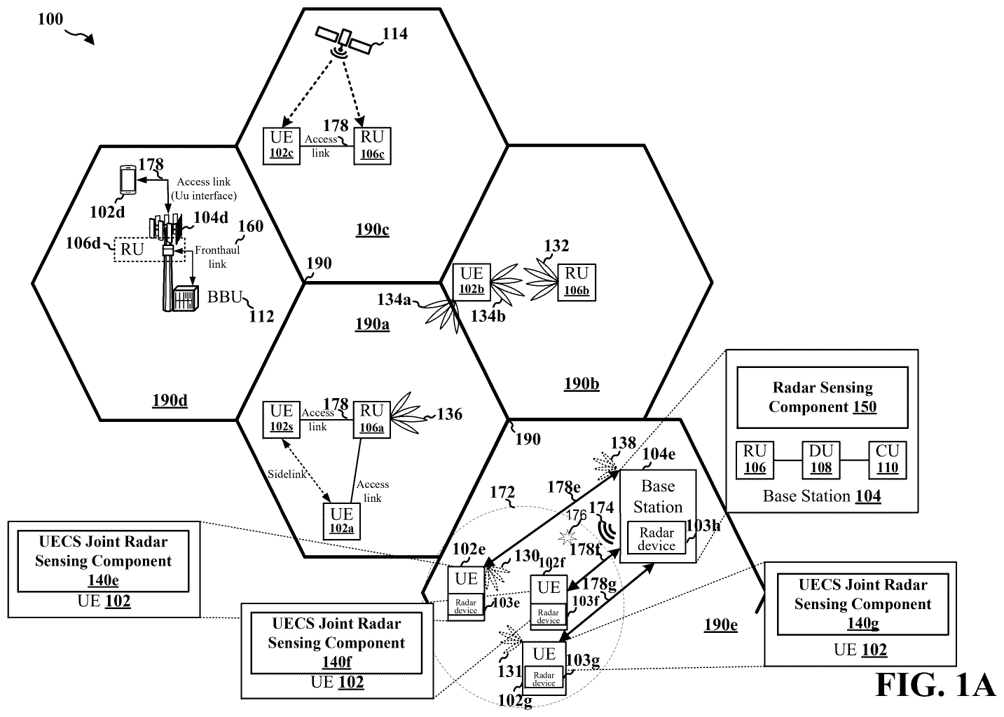

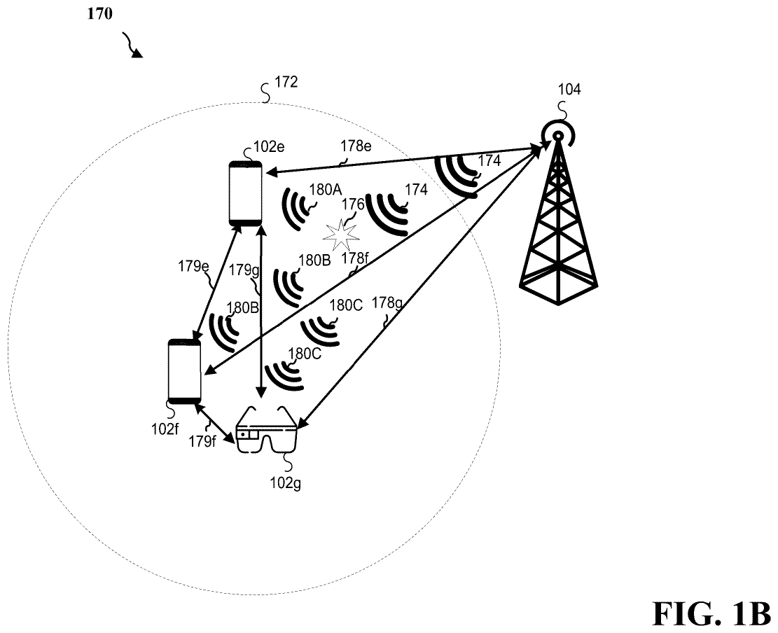

FIG. 1A illustrates a diagram 100 of a wireless communications system associated with a plurality of cells 190. The wireless communications system includes user equipments (UEs) 102 and base stations/network entities 104.

A user equipment-coordination set (UECS) 172 may include UE 102e, 102f, and 102g. Each UE within the UECS 172 can communicate with a coordinating UE (e.g., 102e) and an object UE in the UECS through a side link illustrated as wireless connections 179c, 179f, 179g in FIG. 1B. The UEs 102 may communicate with the base stations 104 (e.g., 104e) via one or more radio frequency (RF) access links 178c, 178f, and 178g. One or more UEs 102 may include a radar device 103c, 103f, 103g, and one or more base stations 104e may include a radar device 103h. A downlink portion of the access link 178 may be combined with a radar signal to result in a combined radar and communication signal. This combined radar and communication signal may use orthogonal time frequency space (OTFS) modulation or orthogonal frequency-division multiplexing (OFDM) modulation. The UEs 102 may transmit to the network entity 104, information using an uplink portion of the access link 178. The UEs 102 can perform radar sensing for imaging an environment or determining information about an object 176 based a reflection of the radar signal 174.

Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d, 104e and/or the RUs 106a, 106b, 106c, 106d may communicate with the UEs 102a, 102b, 102c, 102d, and/or 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beamformed signals. The transmit and receive directions for the UEs 102 and the base stations 104/RUs 106 may or may not be the same.

In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e. The UE 102e communicates with the UE 102g of the cell 190e via a first set of communication beams 130 of the UE 102e and a second set of communication beams 131 of the UE 102g.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 106a can be a secondary node.

Uplink/downlink signaling may also be communicated via a satellite positioning system (SPS) 114. In an example, the SPS 114 associated with the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1A, in certain aspects, any of the UEs 102 may include a UECS joint radar sensing component 140e/140f/140g. For example, the UECS joint radar sensing component is configured to receive, from a first UE, of the UECS, first object detection information for a first radar signal reception; obtain, from a second UE, second object detection information for a second radar signal reception associated with a same transmitted radar signal as the first radar signal reception, the second object detection information being different than the first object detection information; process, at the coordinating UE, the first object detection information together with the second object detection information; and transmit a radar report including joint object detection information of the UECS, the joint object detection information being based on the first object detection information and the second objection detection information.

The UECS joint radar sensing component is configured to transmit, to a UE, of the UECS, first object detection information for a first radar signal reception; receive, from the coordinating UE, joint object detection information including the first object detection information processed together with second object detection information associated with a same transmitted radar signal as the first radar signal reception, the second object detection information being different than the first object detection information; and transmit a radar report including the joint object detection information, the joint object detection information being based on the first object detection and the second objection detection information.

Accordingly, FIG. 1A describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 1B illustrates an example environment 170 for implementing UECS joint radar processing, according to some embodiments. Referring to FIG. 1B, the illustrated example environment includes a network entity 104 (e.g., FIG. 1A element 104e), UE 102c, UE 102f, and UE 102g (e.g., FIG. 1A elements 102e, 102f, and 102g). The UE 102 may be implemented as any suitable computing or wireless smart device, such as an extended reality (XR) headset, mobile communication device, a modem, cellular phone, gaming device, navigation device, media device, laptop computer, desktop computer, tablet computer, smart appliance, vehicle-based communication system, an Internet-of-things (IoT) device (e.g., sensor node, controller/actuator node, combination thereof), and the like. In this example, UE 102e, 102f illustrate smartphones and UE 102g illustrates a smart glass.

Referring to FIG. 1B, the network entity can act as a transmitter transmitting a radar signal. The UE 102e, the UE 102f, or the UE 102g can act as a receiver to perform radar sensing with the network entity 104. Radar sensing can be used for imaging an environment or determining information about an object 176 in the environment based on range, Doppler, and/or angle information determined from a reflected version (e.g., 180A, 180B, 180C) of the radar signal 174. Radar sensing can be employed for automotive radar, e.g., detecting an environment around a vehicle, nearby vehicles, or items, detecting information for smart cruise control, collision avoidance, etc. Radar sensing can also be employed for gesture recognition, e.g., a human activity recognition, a hand motion recognition, a facial expression recognition, a keystroke detection, sign language detection, etc. Radar signal sensing can be employed to acquire contextual information, e.g., location detection, tracking, determining directions, range estimation, etc. Radar sensing can be employed to image an environment, e.g., to provide a 3-dimensional (3D) map for virtual reality (VR) or augmented reality (AR) applications. Radar devices can be employed to provide high resolution localization, e.g., for industrial IoT applications. Radar sensing combined with communication (or also known as integrated sensing and communication) might be a key technology for the next-generation wireless network. For example, autonomous vehicles might require robust sensing capability while receiving from the network entity high-density information such as high-resolution maps. Any suitable radar system may be utilized such as, frequency-modulated continuous-wave (FMCW), pulse-Doppler radar, phase-modulated spread-spectrum radar, impulse radar, or MIMO radar.

FIG. 1B shows the network entity 104 acting as a radar-transmitter, in this example, and transmitting the radar signal 174 for radar sensing. Before the network entity 104 transmits the radar signal, the network entity 104 may configure transmission characteristics of the radar signal 174 (e.g., frequency, bandwidth, and transmit power, beamforming configuration, radar signal modulation type) to achieve a desired detection range, range resolution, or doppler sensitivity, for detecting the object 176.

As depicted in FIG. 1B, in a first example, the UEs within the UECS 172 act as a receiver to assist the network entity 104 to perform joint radar sensing and processing (e.g., bi-static and multistatic). In this example, the UE 102e acts as a coordinating UE. The radar signal 174 propagates through space and reflects off the object 176. Reflected radar signals 180 may represent a reflected version of the radar signal 174. As shown in FIG. 1B, the amplitude of the reflected radar signal 180 is smaller than the amplitude of the radar signal 174 due to various phenomena (e.g., propagation, diffraction, scattering, reflection, and multipath fading). A UE within the UECS receives a reflection 180 of the radar signal 174 reflected from the object 176 as well as the radar signal 174 directly (unreflected). For example, the receiver/radar-assistor 102e receives a reflection 180A of the radar signal 174 reflected from the object 176 as well as the radar signal 174 directly (unreflected). Similarly, UE 102f receives a reflection 180B of the radar signal 174 reflected from the object 176 as well as the radar signal 174 directly (unreflected).

In one example, the UE 102e, UE 102f, and UE 102g perform radar processing. During the radar reception, the UE 102f and 102g demodulate the reflection of the radar signal to generate baseband IQ samples. The UE 102f and 102g samples the baseband IQ samples to generate IQ samples.

The UE 102f and the UE 102g forward the IQ samples to the coordinating UE 102e using the wireless connection 179e, 179g. The coordinating UE 102e, in this embodiment, also obtains IQ samples from itself.

The coordinating UE 102e may perform a preprocessing on the IQ samples before performing data fusion operation on the IQ samples. For example, the coordinating UE 102e performs a data compression (e.g., down sampling, data decimation) to compress the size of the IQ samples to reduce a total runtime of the joint radar processing. The coordinating UE 102e may also perform a filtering operation (e.g., match filtering) to increase the signal-to-noise ratio (SNR) of the IQ samples in the presence noise and increase range resolution.

After the preprocessing, the coordinating UE 102e performs UECS joint radar processing using the IQ samples. For example, the coordinating UE 102e merges (e.g., data fusion operation) the IQ samples from the UEs 102 within the UECS 172. The UE 102f and the UE 102g may also forward UE information (e.g., a location of the UE, an antenna identification (ID) of the UE, or a beam ID of the UE). The coordinating UE 102e merges the IQ samples from the UEs 102 within the UECS 172 based on the UE information.

After the data fusion operation, based on the same UE information, the coordinating UE 102e performs UECS joint radar processing on the merged IQ samples to determine a joint object detection information which includes joint object information about the object 176. For example, the coordinating UE 102e performs UECS joint radar processing to extract object detection information for the merged IQ samples by applying range, Doppler, and beamform processing for the merged IQ samples. In other examples, before the coordination UE merges the IQ samples, the coordinating UE 102e performs radar processing to extract object detection information for the IQ samples by applying range, Doppler, and beamform processing for the IQ samples.

In some examples, the coordinating UE 102e performs an object detection operation based on range-Doppler information (e.g., range-Doppler map) to extract object detection information. For example, the coordinating UE 102e jointly applies an object detection algorithm to determine a presence of the object 176. Then, the coordinating UE 102e determines the range of the object 176. For example, the coordinating UE 102e applies ranging algorithm (e.g., multiple signal classification (MUSIC)) to estimate the azimuth direction and elevation angle of the object.

Then, the coordinating UE 102e, transmits to the UE (102f, 102g) a radar report including joint object detection information of the UECS. After that, the coordinating UE 102e and the UE (102f, 102g) within the UECS 172, jointly transmits the radar report to the network entity 104.

After receiving the radar report, the network entity 104 determines a location of the object 176 based on the joint object detection information of the UECS.

Alternatively, a UE (102e, 102f, 102g) within the UECS 172 performs individual radar processing on the IQ samples to determine an individual radar signal measurement information which includes information about the object 176. For example, the UE 102f performs appropriate radar processing (e.g., preprocessing, filtering, object detection operation, and object ranging as described above) at the UE 102f to determine an individual radar signal measurement information (e.g., range-Doppler information). The UE 102 (102e, 102f, 102g) may determine the range-Doppler information based on the radar-transmitter information (e.g., radar-transmitter position or beam ID) and UE information (e.g., UE's own position and UE beam or angle of arrival).

Each UE (102f, 102g) transmits its individual object detection information to the coordinating UE 102e. The coordinating UE 102e, meanwhile, obtains its own object detection information from itself. The coordinating UE 102e merges all the individual object detection information received from the UE (102f, 102g) within the UECS 172 to determine joint object detection information. Then, the coordinating UE 102e transmits the joint object detection information in a radar report to the UE (102f, 102g) within the UECS 172. After that, the coordinating UE 102e and the UE (102f, 102g) jointly transmit the merged radar signal measurement information.

As described above, after receiving the radar report, the network entity 104 determines a location of the object 176 based on the joint object detection information of the UECS.

Although FIG. 1B illustrates a UECS 172 including three UEs, other numbers of UEs may be included in the UECS 172. Each UE 102 can communicate with the network entity 104 via its own wireless communication link 178. Each UE can communicate each other UEs via local wireless network connections 179, such as a sidelink communication/D2D as previously described in connection with FIG. 1A. In sidelink communication, Physical Sidelink Control Channel (PSCCH) is a physical channel for transmitting control information and Physical Sidelink Shared Channel (PSSCH) is a physical channel for transmitting data in the sidelink communication.

The network entity 104 can specify a set of UEs (e.g., UE 102e, UE 102f, and UE 102g) to form a UECS (e.g., the UECS 172). One of the UEs within the UECS 172 acts as a coordinating UE 102e for the UECS to perform UECS joint radar processing. The network entity 104 can specify the coordinating UE 102e for the UECS. For example, the network entity 104 may specify 102e as the coordinating UE.

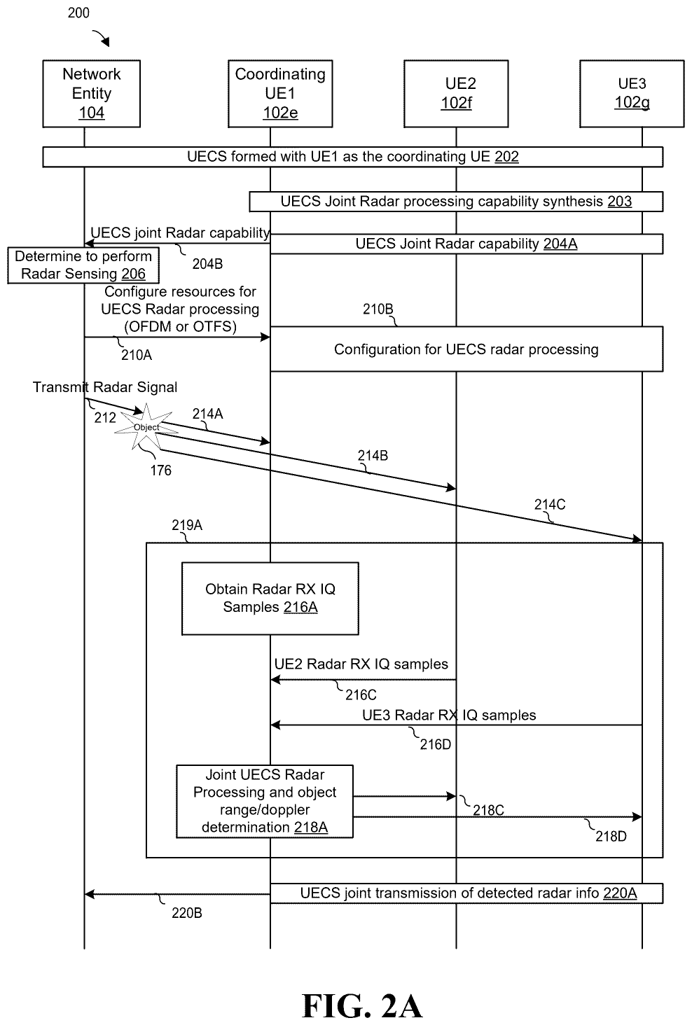

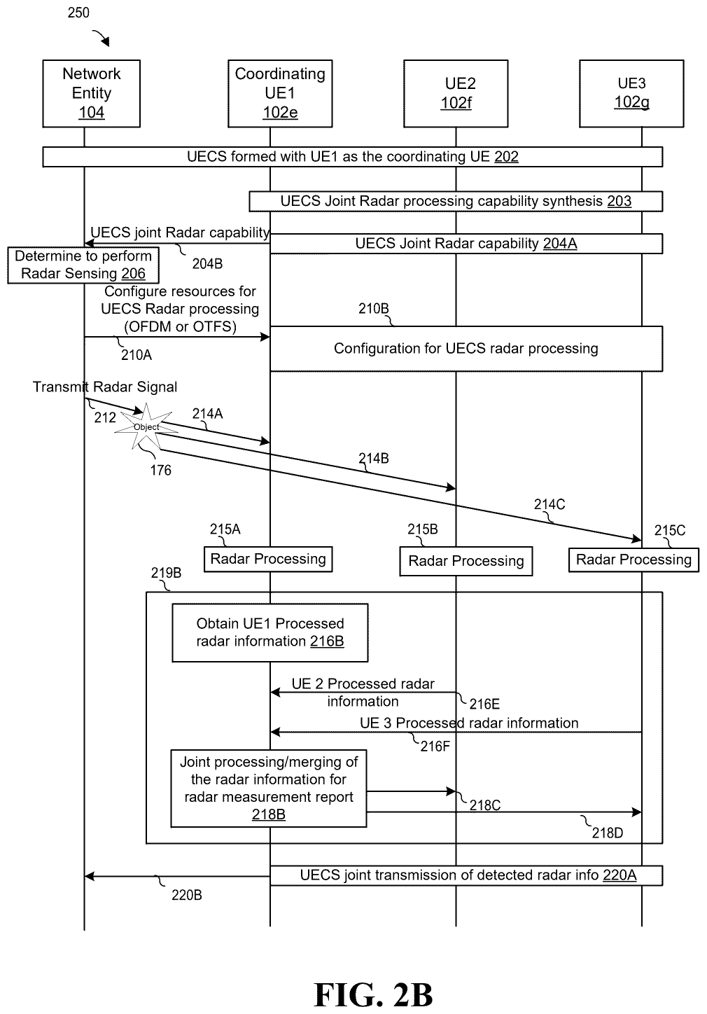

Accordingly, FIGS. 1A to 1B describe example environments in which various aspects of UECS joint radar processing may be implemented in connection with aspects of one or more other figures described herein, such as aspects illustrated in FIGS. 2A-7.

FIG. 2A is a signaling diagram that illustrates example diagram 200 for UECS joint radar processing with a UE 102e (e.g., UE1) as a coordinating UE, UE 102f (e.g., UE2) and/or 102g (e.g., UE3) as radar-receiver UEs, according to some embodiments.

The network entity 104 configures 202 a UECS (e.g., UECS 172). For example, the network entity 104 directs 202 the UE 102e, the UE 102f, and the UE 102g (collectively as UEs 102) to form the UECS 172. The network entity 104 may configure 202 the UE 102e as the coordinating UE for the UECS 172. In other examples, the UE 102e, the UE 102f, and the UE 102g form the UECS 172 on their own, without direction from the network entity 104. In such cases, a UE 102 of the UECS 172 indicates, to the network entity 104, that the UECS 172 has been formed and may also indicate, to the network entity 104, which UE 102 of the UECS 172 is the coordinating UE 102e.

The coordinating UE 102e performs 202 UECS configuration and communication with the other UEs 102 of the UECS 172 (not shown). The network entity 104 might transmit, to the coordinating UE 102e, timing and frequency information for a synchronization signal to synchronize UECS operations among the UEs 102 within the UECS 172. For example, the coordinating UE 102e transmits, to other UEs 102 within the UECS 172, synchronization signals to enable the UE 102f, and the UE 102g to synchronize with the coordinating UE 102e over the local wireless network.

The coordinating UE 102e performs 203 a UECS joint radar processing capability synthesis to generate the UECS capability message indicating a UECS capability for radar processing. The UECS capability message may include an indication of a list of participating UEs selected for the UECS joint radar processing.

To perform 203 the UECS joint radar processing capability synthesis, in some embodiments, the coordinating UE 102e receives 203 a UE capability message from one or more UEs 102 within the UECS advertising its radar capability. The coordinating UE 102e also obtains its own capability message to generate the UECS capability message. In some embodiments, the network entity 104 may request the UEs 102 within the UECS to transmit UE capability information in a UE capability message sent to the coordinating UE 102e.

The UE capability message may include at least one of: radar signal capability, antenna array capability, beamforming capability, processing capability, or GPS capability. The radar signal capability may indicate the type of radar signal the UE is capable of transmitting and receiving. For example, UE 102f can receive and process both OTFS and OFDM radar signals. The antenna array capability may indicate the number of antenna panels of each UE 102. The processing capability may indicate at least one of an available battery level, a thermal condition, processing power, or an available memory. Other UE capabilities may further include the processing capability associated with the modem bandwidth, CPU cycles, and/or memory. In some examples, the UE capability may also include a range or doppler estimation accuracy.

The coordinating UE 102e determines a UECS capability based on a union/intersection of the UE capabilities of the UEs 102 in the UECS 172. For example, the UECS capability message indicates the union of the number of antenna panels of the UEs 102 in the UECS. The coordinating UE 102e might also determine the UECS capability based on an intersection of a subset of UE capabilities, such as UEs 102 capable of performing OTFS radar processing.

In some embodiments, the coordinating UE 102e monitors the UE capability of UE(s) 102 within the UECS and updates the UECS capability message (e.g., at any time) based on individual UE capabilities, such as an updated UE battery level, an updated processing power, and/or an updated UE capability. For example, the coordinating UE 102e updates the UECS capability if the battery level of the UE 102f drops below a predefined threshold.

Based on the UECS capability, the coordinating UE 102e selects 204A the UE(s) to participate in the UECS joint radar processing. The coordinating UE 102e may also determine 204A UE(s) that are not going to participate in the joint UECS radar processing (not shown).

The coordinating UE 102e distributes 204A, to the UEs 102 within the UECS, the UECS capability message. The coordinating UE 102e and the UEs 102 within the UECS jointly transmit 204B, to the network entity 104, the UECS capability message. In other examples, the coordinating UE 102e (or another UE 102 in the UECS) individually transmits 204B, to the network entity 104, the UECS capability message indicating the capability for the selected subgroup of UEs 102 in the UECS.

The network entity 104 determines 206 to perform radar sensing with the UECS (e.g., in response to receiving 204B the UECS joint radar capability message). In some examples, the network entity 104 determines 206 to perform radar sensing with the participating UEs as indicated in the UECS capability message. In other example, the network entity 104 determines 206 to perform radar sensing with a different set (or subset) of UEs 102 from the UECS.

The network entity 104 configures 210A resources (e.g., transmission time and frequency resources) for the UECS to perform UECS joint radar sensing and processing. For example, the network entity 104 transmits 210A a resource grant for propagation of the radar signal between a radar-transmitter and a radar-receiver for the UECS radar sensing. The resource grant may indicate radar receive resources for a radar reception of the radar signal transmitted by a radar-transmitter, such as the network entity 104. The resource grant may also indicate resources for uplink transmissions of the radar signal measurement information by the UECS to the network entity 104. For example, the network entity 104 transmits 210A to the UECS a PDCCH grant indicating uplink resources for a radar signal measurement information. The network entity 104 may transmit 210A, to the UECS, downlink control information (DCI) that indicates the resource grant.

The network entity 104 may transmit 210A, 210B information to the UEs 102 within the UECS to enable the UEs 102 within the UECS to communicate between each other and with the coordinating UE 102e. For example, the network entity 104 transmits information including an ID of the coordinating UE 102e. As another example, the resource grant may also include a local wireless network configuration that enables the UEs 102 to communicate within the UECS.

In some examples, the resources may include an OTFS resource grant (e.g., 2-dimensional (2D) grid in the delay-Doppler domain), transmission slot, frequency bands, waveforms, transmission power level, beam information (e.g., beam ID), etc. For the delay-Doppler resource domain, the OTFS resource grant may indicate the start and the end of a delay grid as well as the start and the end of a Doppler grid. In further examples, the OTFS resource grant includes a bitmap for the allocated delay grid and the allocated doppler grid. The OTFS resource grant may also include radar sequences used in the delay-Doppler domain. The OTFS resource grant may also include the time slot on which the network entity 104 is allowed to transmit the OTFS signal. The time slot includes an upper bound based on the latency requirement of the radar detection and a lower bound based on the minimum delay between a reception of a transmit grant and a time that the network entity 104 performs OTFS signal transmission. The OTFS resource grant may also indicate the transmit power of the OTFS signal. In some other examples, the resources may include an OFDM resource grant (e.g., transmission slot or an OFDM symbol number, frequency domain resource block (RB) allocation, etc.

In some embodiments, the network entity 104 configures 210A the resources in response to successfully receiving 204B a UECS capability message from the UECS. For example, the network entity 104 configures 210A the resources in response to receiving 204B a list of UEs 102 that are capable to perform UECS joint radar processing. In some other embodiments, the network entity 104 configures the resources in response to a request to perform UECS joint radar processing from a UE 102 within the UECS or from a UE outside of the UECS.

In some embodiments, the network entity 104 transmits 210A a configuration including radar signal information (e.g., waveform of the radar signal (OFDM, OTFS), transmission slot, frequency bands, a system frame number (SFN)) of the radar signal, a transmission time of the radar signal, etc.), transmitter information (e.g., radar-transmitter position or beam ID), UE information (e.g., a location of the UE, an antenna ID of the UE, or a beam ID of the UE, cellular timing reference information for synchronization between the transmitter and receiver, beamforming information, etc.).

After the network entity 104 configures the radar air interface resources and transmits 210A that information to at least the coordinating UE 102e, the coordinating UE 102e allocates 210B air interface resources for the local wireless network to the UEs 102 in the UECS. For example, the coordinating UE 102e transmits 210B, to the UEs 102 within the UECS, a configuration for receiving a radar signal and/or one or more reflections plus communication grant for the coordinating UE 102e to receive the object detection information from the participating UEs 102 within the UECS. For example, the coordinating UE 102e transmits 210B, to a UE 102f, radar reception configuration and a sidelink communication grant indicating sidelink resources for a transmission of the IQ samples or radar measurement report message to the coordinating UE 102e. Similarly, the coordinating UE 102e transmits 210B, to the UE 102g and/or any other UE in the UECS, a radar reception configuration and a sidelink communication grant for the transmission the of IQ samples or radar measurement report message to the coordinating UE 102e.

In some embodiments, the coordinating UE 102e configures resources by indicating the type of the object detection information that the coordinating UE 102e is to receive from the UEs 102 for the UECS joint radar processing. In some examples, the coordinating UE 102e indicates that the object detection information is to include IQ samples required for the UECS joint radar processing. In some other examples, the coordinating UE 102e indicates that the object detection information is to include processed measurement information of the radar signal reception, as further described below with respect to FIG. 2B.

After configuring 210A the resources, the network entity 104 generates and transmits 212 a radar signal (e.g., OFDM or OTFS signal as radar waveform) over-the-air for signal reception 214A, 214B, 214C at the UE(s) 102 of the UECS. The radar signal may impinge an object 176 with radar cross section at some distance away from the transmitter. If the radar signal impinges the object 176, a direction and/or characteristics of the radar signal may change. The portion of the radar signal that has impinged on the object is reflected back as a reflection of the radar signal. The portion of the radar signal that does not impinge on the object 176 may travel towards the UE(s) 102 and may be received by one or more UEs 102 within the UECS. In other examples, the radar signal does not impinge an object between the radar-transmitter and the radar-receiver, such that a UE 102 may receive 214 the radar signal directly from the radar-transmitter/network entity 104.

The UE(s) 102 within the UECS may receive the radar signal and/or the reflection of the radar signal. For example, the coordinating UE 102e receives 214A the reflection of the radar signal, the UE 102f receives 214B the reflection of the radar signal, and the UE 102g receives 214C the reflection of the radar signal.

The coordinating UE 102e, the UE 102f, and the UE 102g perform 219A UECS joint radar processing. For example, in the initial phase of the radar processing, the UE 102e, UE 102f, and UE 102g demodulate the reflection of the radar signal using a quadrature local oscillator to generate baseband IQ samples. Each UE 102e, 102f, and 102g samples its baseband IQ samples to generate IQ samples. The UE 102f forwards 216C the IQ samples to the coordinating UE 102e using the wireless connection 179e (e.g., sidelink, local wireless network). Similarly, the UE 102g forwards 216D the IQ samples to the coordinating UE 102e. The UE 102e obtains 216A its own IQ samples. After receiving 216C-216D and obtaining 216A the IQ samples, the coordinating UE 102e performs data fusion on the IQ samples to perform 218A joint radar processing.

The UE 102f and the UE 102g may also forward UE information (e.g., a location of the UE, an antenna ID of the UE, cellular timing reference information, beamforming information (e.g., a beam ID of the UE, a number of beam ID, antenna module, etc.)). The UEs 102 within the UECS may use beamforming information to perform beamforming and detect angle of arrival of the radar signal. The UEs 102 within the UECS may use direction information included in the beamforming information to reduce interference that is caused by the radar signal (unreflected) that travels directly from the transmitter to the receiver. The UEs 102 within the UECS control the direction of the receiving antenna based on the beamforming information to reduce the probability of a direct path interference radar signal from the transmitter.

In some embodiments, the coordinating UE 102e may determine the UE information (e.g., a location of the UE) of the UEs 102 within the UECS. For example, the coordinating UE 102e determines the location of the UE 102f and UE 102g based on the location information transmitted from the UE 102f and UE 102g.

In some embodiments, the UEs 102 within the UECS may also forward timing information associated with the radar signal. For example, the UE 102f and the UE 102g forward the time at which the reception 214 of the reflected signal at the UE occurs.

Based on the same UE information, the coordinating UE 102e performs 218A joint radar processing on the IQ samples to determine a merged radar signal measurement information which indicates information about the object 176. For example, the coordinating UE 102e merges or fuses the IQ samples to extract object detection and direction information for the IQ samples by applying range, Doppler, and beamform processing for all the IQ samples.

In embodiments, the coordinating UE 102e performs initial processing and filtering prior to the joint radar processing to compress the size of the IQ samples. In some other embodiments, the coordinating UE 102e performs data decimation and down sampling to reduce the size of the IQ samples. The coordinating UE 102e may generate a range-Doppler map and determine measurement information which includes information about the object 176. The UE 102e generates the range-Doppler map by converting a fast time to range and a slow time to Doppler by applying Fourier Transforms.

In some embodiments, the coordinating UE 102e may also transfer its UECS joint radar processing responsibility to another UE 102 within the UECS based on various factors such as UE capability, battery level, and processing power.

The coordinating UE 102e, along with other UEs within the UECS, jointly transmits 220A, 220B the merged radar signal measurement information to the network entity 104. In some embodiments, the coordinating UE 102e (or another UE 102 within the UECS) may also independently transmit 220B the merged radar signal measurement to the network entity 104 or transmit the merged radar signal measurement information to another UE 102 within the UECS or a UE outside of the UECS.

FIG. 2A shows the UE within the UECS forwarding the IQ samples to the coordinating UE 102e for a joint radar processing. FIG. 2B shows the UE within the UECS performing individual radar processing and forwarding the processed measurement of the radar signal coordinating UE 102e for a joint radar processing.

FIG. 2B illustrates a diagram 250 for UECS joint radar processing with a UE 102e as a coordinating UE. Elements 202, 203, 204A, 204B, 210A, 210B, 212, 214A, 214B, 214C, 220A, 220B of FIG. 2B have already been described with respect to FIG. 2A.

Referring to FIG. 2B, where the UE 102f, 102g within the UECS transmits 216E-216F the object detection information to the coordinating UE 102e, after the UEs 102 within the UECS perform 215 individual radar processing.

In embodiments, the coordinating UE 102e may determine where the radar processing of the radar signal takes place. The coordinating UE 102e determines the UEs 102 within the UECS should perform individual processing of the radar signal before the UECS joint radar processing at the coordinating UE 102e. For example, after the coordinating UE 102e receives 214A the reflected radar signal, the coordinating UE 102e performs 215A radar processing on the reflected radar signal to detect the object 176. Similarly, the UE 102f performs 215B radar processing and the UE 102g performs 215C radar processing on the reflected radar signal to detect the object 176. The UEs 102f, 102g analyze the reflected radar signal to determine object information about the object 176 to be included in a radar measurement report.

The coordinating UE 102e, the UE 102f, and the UE 102g perform 219B UECS joint radar processing. The UE 102f transmits 216E, to the coordinating UE 102e, the radar measurement report. The coordinating UE 102e similarly receives 216E another radar measurement report from the UE 102g. The coordinating UE 102e obtains 216B yet another radar measurement itself, based on the radar processing 215A. The coordinating UE 102e jointly processes 218B all of the obtained/received 216 radar measurements from the UEs 102 of the UECS. The radar measurement report may include at least one of movement information (e.g., Doppler frequency or velocity), position information (e.g., distance or angle), size information (e.g., length, width, or height), or material or surface composition information (e.g., a reflection coefficient or radar cross section).

The coordinating UE 102e performs 218B the joint radar processing of the radar measurement information to generate a merged radar signal measurement information which includes information about the object 176. For example, the coordinating UE 102e merges 218B the radar measurement information to generate a joint object detection information included in a radar report. The benefit of merging the radar measurement information is to obtain a more accurate estimate of the object information.

The coordinating UE 102e distributes 218C-218D joint object detection information of the UECS to the UEs 102f, 102g within the UECS (e.g., radar report). For example, the coordinating UE 102e transmits 218C the joint object detection information to the UE 102f. Similarly, the coordinating UE 102e transmits 218D the joint object detection information to the UE 102g.

The UEs 102 within the UECS including the coordinating UE 102e (which could number more than or less than the number of UEs participating in the radar processing) jointly transmit 220A, 220B the radar report to the radar-transmitter/network entity 104. The network entity 104 receives the jointly-transmitted radar report from the UE 102e, 102f, 102g and processes the jointly-transmitted radar report to detect the object 176. In some embodiments, the coordinating UE 102e (or another UE 102 within the UECS or outside the UECS) may independently transmit 220B the radar report to the network entity 104. By compiling information about the object 176 from the UECS, the network entity 104 can obtain information about an operating environment, such as the environment 170 illustrated in FIG. 1B. With such information about the environment 170, for example, the network entity 104 can generate a map of the environment 170 including the location of the object 176.

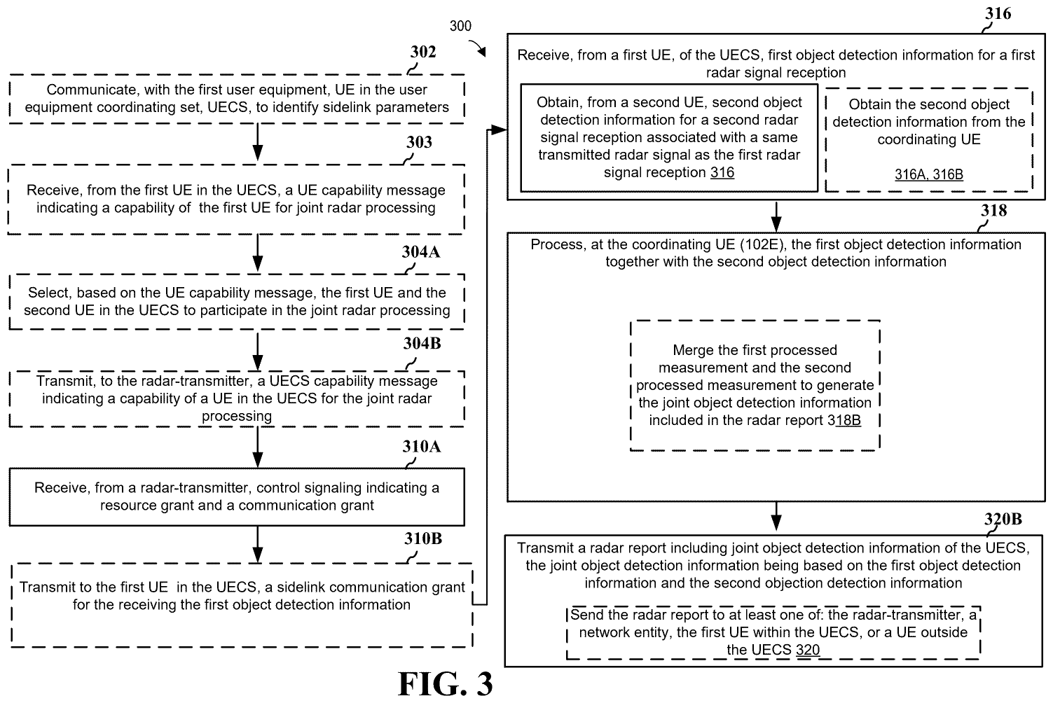

While FIG. 2B shows an example scenario for UECS joint radar processing, FIG. 3 describes a procedure 300 for UECS joint radar processing implemented by the coordinating UE 102e.

FIG. 3 shows a flow diagram of a procedure 300 implemented by the coordinating UE 102e within the UECS 172 depicted in FIGS. 1A-1B. With reference to FIGS. 1A-2B, the method may be performed by the UE 102.

The coordinating UE 102e communicates 302, with a first UE (102f, 102g) in the UECS, to identify sidelink parameters for at least one of: the receiving 316, 317 at least one of the first object detection information and or the obtaining 316A, 316B the second object detection information. For example, referring to FIGS. 2A-2B, the coordinating UE 102e performs 202 UECS configuration and communication with the UEs 102f, 102g.

The coordinating UE 102e receives 303, from the first UE (102f, 102g) in the UECS, a UE capability message indicating a capability of the first UE (102f, 102g) for joint radar processing. For example, referring to FIGS. 2A-2B, the coordinating UE 102e receives 203 a UE capability message indicating a capability of UE 102f and UE 102g to determine a UECS capability message.

The coordinating UE 102e selects 304A the first UE (102f, 102g) and the second UE (102e, 102f, 102g) in the UECS to participate in the joint radar processing. For example, the coordinating UE 102e selects 204A the UE to participate in the joint UECS radar processing.

The coordinating UE 102e transmits 304B, to the radar-transmitter 104, a UECS capability message indicating a capability of a UE (102) in the UECS for the joint radar processing. For example, referring to FIGS. 2A-2B, the coordinating UE 102e and the UE within the UECS jointly transmits 204B, to the network entity 104, the UECS joint radar capability message.

The coordinating UE 102e receives 310A, from a radar-transmitter 104, control signaling indicating a resource grant and a communication grant. For example, referring to FIGS. 2A-2B, the coordinating UE 102e receives 210A, from a network entity 104, a sidelink communication grant for an intra-transmission within the UECS.

The coordinating UE 102e transmits 310B to the first UE (102f, 102g) in the UECS, a radar resource configuration and a sidelink communication grant for the receiving 216C-216F the first object detection information. For example, referring to FIGS. 2A-2B, the coordinating UE 102e transmits 210B, to the UE (102f, 102g), the coordinating UE 102e transmits 210B, to the UE within the UECS, communication resources (e.g., transmission time and frequency resources) for the coordinating UE 102e to receive the object detection information from the UE within the UECS.

The coordinating UE 102e receives 316, from the UE (102f, 102g) of the UECS, first object detection information for a first radar signal reception. For example, referring to FIG. 2A, the coordinating UE 102e receives 216C the IQ samples from the UE 102f using the wireless connection 179e (e.g., sidelink, local wireless network). In some other examples, the coordinating UE 102e receives 216E the radar measurement report from the UE 102f.

In some examples, the coordinating UE 102e obtains 316, from a second UE (102e, 102f, 102g), second object detection information for a second radar signal reception associated with a same transmitted radar signal as the first radar signal reception.

In other examples, the coordinating UE 102e obtains 316A, 316B the second object detection information from the coordinating UE 102e. For example, referring to FIG. 2A, the UE 102e obtains 216A its own IQ samples. In another example, referring to FIG. 2B, the UE 102e obtains 216B the radar measurement report from itself.

The coordinating UE 102e processes 318, at the coordinating UE 102e, the first object detection information together with the second object detection information. For example, referring to FIG. 2A, the coordinating UE 102e performs 218A UECS joint radar processing on the IQ samples to determine a joint object detection measurement information which includes information about the object 176.

In further examples, to process the first objection detection together with the second object detection information, the coordinating UE 102e merges 318B the first processed measurement and the second processed measurement to generate the joint object detection information included in the radar report. For example, referring to FIG. 2B, the coordinating UE 102e merges 218B the radar measurement report transmitted by the UE within the UECS to generate a joint object detection information included in a radar report. The coordinating UE 102e transmits 320B a radar report including joint object detection information of the UECS, the joint object detection information being based on the first object detection information and the second objection detection information. For example, referring to FIGS. 2A-2B, the coordinating UE 102e, with the UE within the UECS, jointly transmits 220A, 220B the merged radar signal measurement information to the network entity 104. In examples, the coordinating UE 102e sends 320B the radar report to at least one of: the radar-transmitter, a network entity, the first UE within the UECS, or a UE outside the UECS.

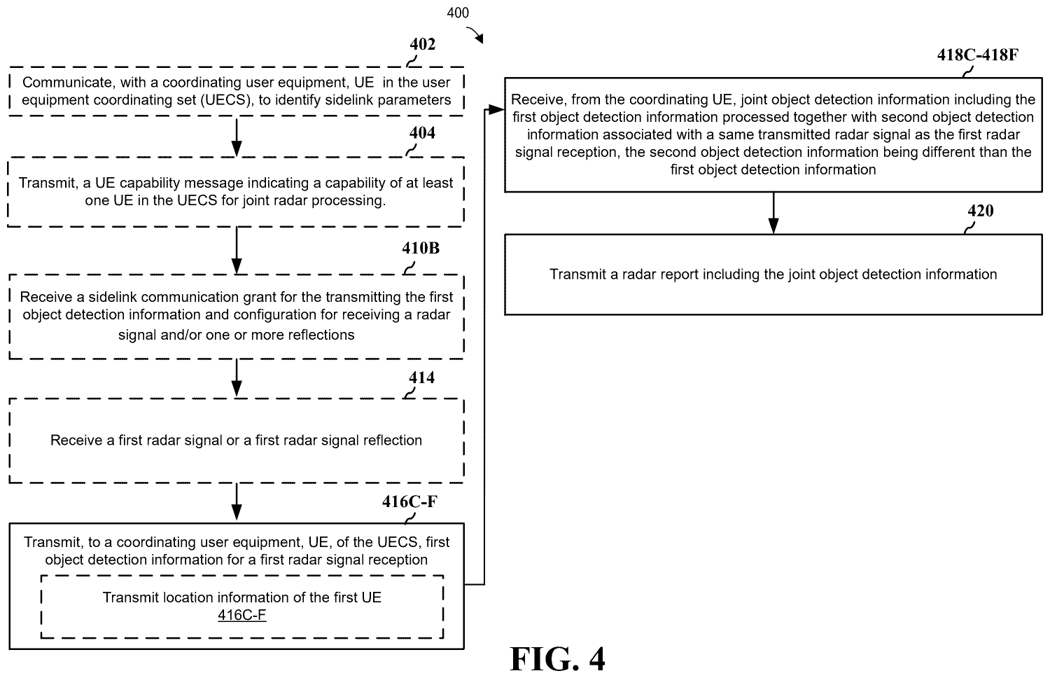

FIG. 3 describes a method of a coordinating UE 102e for UECS joint radar processing, whereas FIG. 4 describes a method of a UE within the UECS for UECS joint radar processing.

FIG. 4 shows a flow diagram of a procedure 400 implemented by the UE 102 (102f, 102g) within the UECS 172 depicted in FIGS. 1A-1B. With reference to FIGS. 1A-2B, the method may be performed by the UE 102.

The UE within the UECS communicates 402, with a coordinating UE 102e in the UECS, to identify sidelink parameters. For example, referring to FIGS. 2A-2B, the UEs 102f, 102g performs 202 UECS configuration and communication with the coordinating UE 102e.

The UE within the UECS transmits 404 a UECS capability message indicating a capability of at least one UE (102e, 102f, 102g) in the UECS for joint radar processing. For example, referring to FIGS. 2A-2B, the UE within the UECS transmits 204B, to the radar-transmitter 104, a UECS capability message indicating a capability of a UE 102 in the UECS for the joint radar processing.

The UE within the UECS receives 410B from the coordinating UE 102e, a sidelink communication grant for the transmitting (216C-216F) the first object detection information. For example, referring to FIGS. 2A-2B, the UE within the UECS receives from the coordinating UE 102e sidelink communication grant for the UE to transmit the object detection information to the coordinating UE. The UE within the UECS also receives 410B configuration for the receiving a radar signal and/or one or more reflections.

The UE within the UECS receives 414 a first radar signal or a first radar signal reflection. For example, referring to FIGS. 2A-2B, the UE within the UECS receives 214A the reflection of the radar signal, the UE 102f receives 214B the reflection of the radar signal, and the UE 102g receives 214C the reflection of the radar signal. In another example, the radar signal does not impinge an object between the radar-transmitter and the radar-receiver, such that a UE 102 receives 214 the radar signal directly from the radar-transmitter/network entity 104.

The UE within the UECS transmits 416C-416F, to a coordinating UE 102e of the UECS, first object detection information for a first radar signal reception. For example, referring to FIG. 2A, the UE 102 transmits 216C, 216D, to the coordinating UE 102e, IQ samples. In other examples, referring to FIG. 2B, the UE 102 transmits 216E, 216F, to the coordinating UE 102e, the radar measurement report.

The UE within the UECS transmits 416C-416F information of the first UE. For example, referring to FIGS. 2A-2B, the UE 102f and the UE 102g transmits 216-216F, to the coordinating UE 102e, UE information (e.g., a location of the UE, an antenna identification (ID) of the UE, or a beam ID of the UE).

The UE within the UECS receives 418C-418F, from the coordinating UE 102e, joint object detection information including the first object detection information processed together with second object detection information associated with a same transmitted radar signal as the first radar signal reception. The second object detection information is different than the first object detection information. For example, referring to FIGS. 2A-2B, the UE (102f, 102g) receives 218C, 218D, joint object detection information from the coordinating UE 102e.

The UE within the UECS transmits 420 a radar report including the joint object detection information. The joint object detection information is based on the first object detection and the second objection detection information. For example, referring to FIGS. 2A-2B, the UE 102f, with the UE within the UECS, jointly transmits 220A the merged radar signal measurement information to the network entity 104.

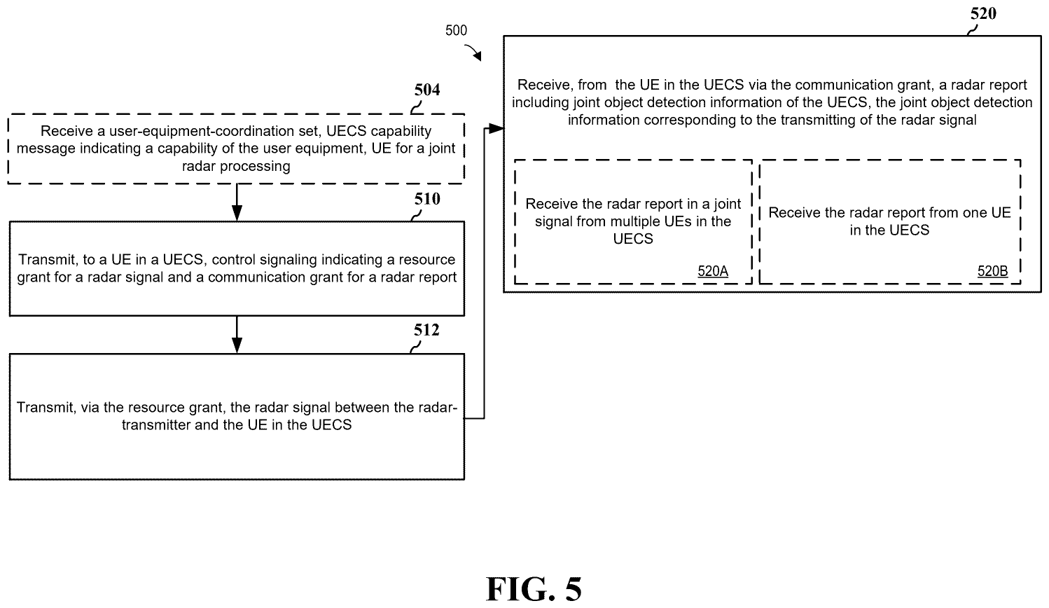

FIG. 4 describes a method of a UE within the UECS for UECS joint radar processing, whereas FIG. 5 describes a method of a radar-transmitter for UECS joint radar processing.

FIG. 5 is a flowchart 500 of a of a radar-transmitter for UECS joint radar processing. With reference to FIGS. 1A-2B, the method may be performed by one or more network entities 104, which may correspond to a base station or a unit of the base station, such as the RU 106, the DU 108, and/or the CU 110. The method may also be performed by the UE 102.

The radar-transmitter receives 504 a UECS capability message indicating a capability of the UE 102 for a joint radar processing. For example, referring to FIGS. 2A-2B, the network entity 104 receives 204B, from a UE (102e, 102f, 102g) within the UECS, a UECS capability message.

The radar-transmitter transmits 510, to a UE 102 in the UECS, control signaling indicating a resource grant for a radar signal and a communication grant for a radar report. For example, referring to FIGS. 2A-2B, the network entity 104 transmits 210A a resource grant for propagation of the radar signal between a transmitter and a receiver for the UECS radar sensing. The resource grant also indicates an uplink communication grant for a transmission of the radar report to the network entity 104.

The radar-transmitter transmits 512, via the resource grant, the radar signal between the radar-transmitter 104 and the UE 102 in the UECS. For example, referring to FIGS. 2A-2B, the network entity 104 generates and transmits 212 a radar signal (e.g., OFDM or OTFS signal as radar waveform) over-the-air for signal reception 214A, 214B, 214C.

The radar-transmitter receives 520, from the UE 102 in the UECS via the communication grant, a radar report including joint object detection information of the UECS. The joint object detection information corresponds to the transmitting 512 of the radar signal. For example, referring to FIGS. 2A-2B, the network entity 104 receives 220, from the UE 102 (102f, 102g) within the UECS, a merged radar signal measurement information.

In some examples, the radar-transmitter receives 520A the radar report in a joint signal from multiple UEs 102 in the UECS. For example, referring to FIGS. 2A-2B, the network entity 104 receives 220A, from the UE 102 (102f, 102g) within the UECS, a merged radar signal measurement information.

In other examples, the radar-transmitter receives 520B the radar report from one UE 102 in the UECS. For example, referring to FIGS. 2A-2B, the network entity 104 receives, from the UE 102 (102f, 102g) within the UECS, a merged radar signal measurement information.

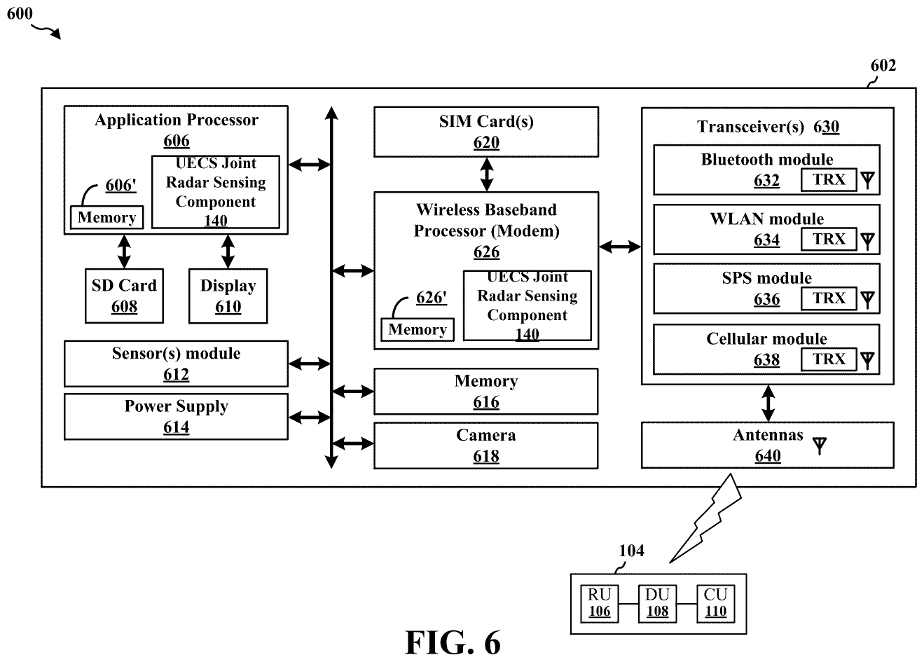

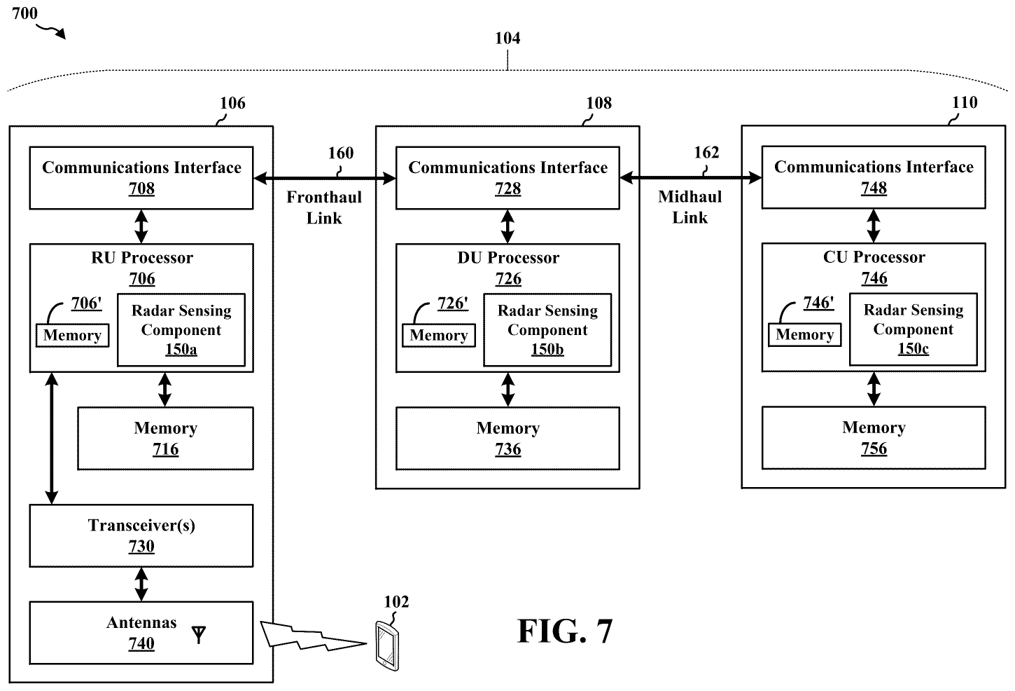

A UE apparatus 602, as described in FIG. 6, may perform the method of flowcharts 300 and 400. The one or more network entities 104, as described in FIG. 7, may perform the method of flowchart 500.

FIG. 6 is a diagram 600 illustrating an example of a hardware implementation for a UE apparatus 602. The UE apparatus 602 may be the UE 102, a component of the UE 102, or may implement UE functionality. The UE apparatus 602 may include an application processor 606, which may have on-chip memory 606′. In examples, the application processor 606 may be coupled to a secure digital (SD) card 608 and/or a display 610. The application processor 606 may also be coupled to a sensor(s) module 612, a power supply 614, an additional module of memory 616, a camera 618, and/or other related components. For example, the sensor(s) module 612 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 602 may further include a wireless baseband processor 626, which may be referred to as a modem. The wireless baseband processor 626 may have on-chip memory 626′. Along with, and similar to, the application processor 606, the wireless baseband processor 626 may also be coupled to the sensor(s) module 612, the power supply 614, the additional module of memory 616, the camera 618, and/or other related components. The wireless baseband processor 626 may be additionally coupled to one or more subscriber identity module (SIM) card(s) 620 and/or one or more transceivers 630 (e.g., wireless RF transceivers).

Within the one or more transceivers 630, the UE apparatus 602 may include a Bluetooth module 632, a WLAN module 634, an SPS module 636 (e.g., GNSS module), and/or a cellular module 638. The Bluetooth module 632, the WLAN module 634, the SPS module 636, and the cellular module 638 may each include an on-chip transceiver (TRX), or in some cases, just a transmitter (TX) or just a receiver (RX). The Bluetooth module 632, the WLAN module 634, the SPS module 636, and the cellular module 638 may each include dedicated antennas and/or utilize antennas 640 for communication with one or more other nodes. For example, the UE apparatus 602 can communicate through the transceiver(s) 630 via the antennas 640 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 626 and the application processor 606 may each include a computer-readable medium/memory 626′, 606′, respectively. The additional module of memory 616 may also be considered a computer-readable medium/memory. Each computer-readable medium/memory 626′, 606′, 616 may be non-transitory. The wireless baseband processor 626 and the application processor 606 may each be responsible for general processing, including execution of software stored on the computer-readable medium/memory 626′, 606′, 616. The software, when executed by the wireless baseband processor 626/application processor 606, causes the wireless baseband processor 626/application processor 606 to perform the various functions described herein. The computer-readable medium/memory may also be used for storing data that is manipulated by the wireless baseband processor 626/application processor 606 when executing the software. The wireless baseband processor 626/application processor 606 may be a component of the UE 102. The UE apparatus 602 may be a processor chip (e.g., modem and/or application) and include just the wireless baseband processor 626 and/or the application processor 606. In other examples, the UE apparatus 602 may be the entire UE 102 and include the additional modules of the apparatus 602.

As discussed in FIG. 1 and implemented with respect to FIG. 3, the UECS joint radar sensing component 140 is configured to receive, from a first UE, of the UECS, first object detection information for a first radar signal reception; obtain, from a second UE, second object detection information for a second radar signal reception associated with a same transmitted radar signal as the first radar signal reception, the second object detection information being different than the first object detection information; process, at the coordinating UE, the first object detection information together with the second object detection information; and transmit a radar report including joint object detection information of the UECS, the joint object detection information being based on the first object detection information and the second objection detection information.

With respect to FIG. 4, the UECS joint radar sensing component is configured to transmit, to a UE, of the UECS, first object detection information for a first radar signal reception; receive, from the coordinating UE, joint object detection information including the first object detection information processed together with second object detection information associated with a same transmitted radar signal as the first radar signal reception, the second object detection information being different than the first object detection information; and transmit a radar report including the joint object detection information, the joint object detection information being based on the first object detection and the second objection detection information.

The UECS joint radar sensing component 140 may be within the application processor 606 (e.g., at 140a), the wireless baseband processor 626 (e.g., at 140b), or both the application processor 606 and the wireless baseband processor 626. The UECS joint radar processing component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 7 is a diagram 700 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 746, which may have on-chip memory 746′. In some aspects, the CU 110 may further include an additional module of memory 756 and/or a communications interface 748, both of which may be coupled to the CU processor 746. The CU 110 can communicate with the DU 108 through a midhaul link 162, such as an F1 interface between the communications interface 748 of the CU 110 and a communications interface 728 of the DU 108.

The DU 108 may include a DU processor 726, which may have on-chip memory 726′. In some aspects, the DU 108 may further include an additional module of memory 736 and/or the communications interface 728, both of which may be coupled to the DU processor 726. The DU 108 can communicate with the RU 106 through a fronthaul link 160 between the communications interface 728 of the DU 108 and a communications interface 708 of the RU 106.

The RU 106 may include an RU processor 706, which may have on-chip memory 706′. In some aspects, the RU 106 may further include an additional module of memory 716, the communications interface 708, and one or more transceivers 730, all of which may be coupled to the RU processor 706. The RU 106 may further include antennas 740, which may be coupled to the one or more transceivers 730, such that the RU 106 can communicate through the one or more transceivers 730 via the antennas 740 with the UE 102.

The on-chip memory 706′, 726′, 746′ and the additional modules of memory 716, 736, 756 may each be considered a computer-readable medium/memory. Each computer-readable medium/memory may be non-transitory. Each of the processors 706, 726, 746 is responsible for general processing, including execution of software stored on the computer-readable medium/memory. The software, when executed by the corresponding processor(s) 706, 726, 746 causes the processor(s) 706, 726, 746 to perform the various functions described herein. The computer-readable medium/memory may also be used for storing data that is manipulated by the processor(s) 706, 726, 746 when executing the software. In examples, the radar sensing component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 5, the radar sensing component 150 is configured to transmit, to a UE, in a UECS, control signaling indicating a resource grant for a radar signal and a communication grant for a radar report; transmit, via the resource grant, the radar signal between the radar-transmitter and the UE in the UECS; and receive, from the UE in the UECS via the communication grant, a radar report including joint object detection information of the UECS, the joint object detection information corresponding to the transmitting of the radar signal.

The radar sensing component 150 may be within one or more processors of the one or more network entities 104, such as the RU processor 706 (e.g., at 150a), the DU processor 726 (e.g., at 150b), and/or the CU processor 746 (e.g., at 150c). The radar sensing component 150a-150c may be one or more hardware components specifically configured to carry out the stated processes/algorithm, implemented by one or more processors 706, 726, 746 configured to perform the stated processes/algorithm, stored within a computer-readable medium for implementation by the one or more processors 706, 726, 746, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more. Terms or articles such as “a”, “an”, and/or “the” may refer to one of an item, feature, element, etc., that the term or article precedes, or may refer to more than one of said item, feature, clement, etc. that the term or article precedes. For example, the recitation “a widget” does not preclude reference to multiples of said widget, as “multiple widgets” necessarily includes “a widget”. Hence, the recitation “a widget” may be interpreted as “at least one widget” or, similarly, interpreted as “one or more widgets”.

Unless otherwise specifically indicated, ordinal terms such as “first” and “second” do not necessarily imply an order in time, sequence, numerical value, etc., but are used to distinguish between different instances of a term or phrase that follows each ordinal term.

Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers but have one or more of the same trailing numbers (e.g., 206, 306, 406, etc., may refer to similar features in the drawings). Hence, like numbers may refer to like actions.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a coordinating UE, including: receiving from a first user equipment, UE, of the UECS, first object detection information for a first radar signal reception; obtaining, from a second UE, second object detection information for a second radar signal reception associated with a same transmitted radar signal as the first radar signal reception, the second object detection information being different than the first object detection information; processing, at the coordinating UE, the first object detection information together with the second object detection information; and transmitting a radar report including joint object detection information of the UECS, the joint object detection information being based on the first object detection information and the second objection detection information.

Example 2 may be combined with Example 1 and further includes that the processing includes data fusion of the first object detection information together with the second object detection information.

Example 3 may be combined with Example 1 and further includes that the first object detection information includes first in-phase and quadrature, IQ, samples of the first radar signal reception and the second object detection information includes second IQ samples of the second radar signal reception.

Example 4 may be combined with Example 1 and further includes that first IQ samples are processed together with at least one of: the second IQ samples, location information of a radar-transmitter, location information of the first UE, or location information of the second UE, to generate the joint object detection information included in the radar report.

Example 5 may be combined with Example 1 and further includes that the first object detection information indicates a first processed measurement of the first radar signal reception and the second object detection information indicates a second processed measurement of the second radar signal reception, the first processed measurement and the second processed measurement including information about an object.

Example 6 may be combined with Example 5 and further includes that the processing the first object detection information together with the second object detection information, includes merging the first processed measurement and the second processed measurement to generate the joint object detection information included in the radar report, the first processed measurement being generated based on location information of the radar-transmitter and location information of the first UE, the second processed measurement being generated based on the location information of the radar-transmitter and location information of the second UE.

Example 7 may be combined with any Examples 1-6 and further includes that the processing the first object detection information together with the second object detection information is based at least one of: the second object detection information received from the second UE, or the second object detection information generated by the coordinating UE.

Example 8 may be combined with any Examples 1-7 and further includes that the first object detection information and the second object detection information includes at least one of: a location of the first UE, an antenna identification, ID, of the UE, a beam ID of the UE, the IQ samples before orthogonal time-frequency space, OTFS, processing, the IQ samples after the OTFS processing, the IQ samples with partial OTFS processing, the IQ samples before orthogonal frequency-division multiplexing, ODFM, processing, the IQ samples after the OFDM processing, or the IQ samples with partial OFDM processing.

Example 9 may be combined with any Examples 1-7 and further includes transmitting to the first UE, in the UECS, a sidelink communication grant for the receiving the first object detection information.

Example 10 may be combined with any Examples 1-9 further and further includes that the obtaining the second object detection information includes obtaining the second object detection information from the coordinating UE.

Example 11 may be combined with any Examples 1-10 and further includes receiving, from a radar-transmitter, control signaling indicating a resource grant and a communication grant, the resource grant being for transmission of a radar signal between the radar-transmitter and the UECS, the communication grant being for the transmitting the radar report.

Example 12 may be combined with any Examples 1-12 and further includes communicating, with the first UE, in the UECS, to identify sidelink parameters for at least one of: the receiving the first object detection information or the obtaining the second object detection information.

Example 13 may be combined with any Examples 1-12 and further includes receiving, from the first UE, in the UECS, a UE capability message indicating a capability of the first UE, for joint radar processing.

Example 14 may be combined with any Example 13 and further includes selecting, based on the UE capability message, the first UE, and the second UE in the UECS to participate in the joint radar processing.

Example 15 may be combined with any Examples 13-14 and further includes that the UE capability message indicates at least one of: an available battery level, a thermal condition, an available memory, a processing capability, or a UE location.

Example 16 may be combined with any Examples 1-15 and further includes transmitting to the radar-transmitter a UECS capability message indicating a capability of a UE in the UECS for the joint radar processing.

Example 17 may be combined Example 16 and further includes selecting based on a predetermined criterion, at least one UE in the UECS to participate in the joint radar processing, the predetermined criterion being at least one of a minimum radar range resolution or a minimum radar Doppler resolution.

Example 18 may be combined with any Examples 1-17 and further includes that the transmitting the radar report includes: sending the radar report to at least one of: the radar-transmitter, a network entity, the first UE within the UECS, or a UE outside the UECS.

Example 19 is a method of wireless communication at a UE of a UECS, including: transmitting to a coordinating user equipment, UE of the UECS, first object detection information for a first radar signal reception; receiving from the coordinating UE joint object detection information including the first object detection information processed together with second object detection information associated with a same transmitted radar signal as the first radar signal reception, the second object detection information being different than the first object detection information; and transmitting a radar report including the joint object detection information.

Example 20 may be combined with Example 19 and further includes that the first object detection information includes in-phase and quadrature, IQ, samples of the first radar signal reception.

Example 21 may be combined with Example 20 and further includes transmitting location information of the first UE.

Example 22 may be combined with Example 19 and further includes that the first object detection information indicates a first processed measurement of the first radar signal reception, the first processed measurement indicating information about an object.

Example 23 may be combined with any Examples 20-22 and further includes that the first object detection information includes at least one of: a location of the UE, an antenna identification, ID, of the UE, a beam ID of the UE, the IQ samples before orthogonal time-frequency space, OTFS, processing, the IQ samples after the OTFS processing, the IQ samples with partial OTFS processed, the IQ samples before orthogonal frequency-division multiplexing, ODFM, processing, the IQ samples after the OFDM processing, or the IQ samples with partial OFDM processing.

Example 24 may be combined with any Examples 19-23 and further includes receiving from the coordinating UE a sidelink communication grant for the transmitting the first object detection information.

Example 25 may be combined with any Examples 19-24 and further includes transmitting a UE capability message indicating a capability of at least one UE in the UECS for joint radar processing.

Example 26 may be combined with Example 25 and further includes that the UE capability message indicates at least one of: an available battery level, a thermal condition, an available memory, a processing capability, or a UE location.

Example 27 may be combined with any Examples 19-26 and further includes communicating, with the coordinating UE to identify sidelink parameters for at least one of: the transmitting the first object detection information.

Example 28 is a method of wireless communication at a radar-transmitter, including: transmitting, to a user equipment, UE, in a user-equipment-coordination set, UECS, control signaling indicating a resource grant for a radar signal and a communication grant for a radar report; transmitting, in conformance with the resource grant, the radar signal between the radar-transmitter and the UE in the UECS; and receiving, from the UE in the UECS via the communication grant, a radar report including joint object detection information of the UECS, the joint object detection information corresponding to the transmitting of the radar signal.

Example 29 may be combined with Example 28 and further includes that the receiving the radar report includes at least one of: receiving the radar report in a joint signal from multiple UEs in the UECS or receiving the radar report from one UE in the UECS.

Example 30 may be combined with any Examples 28-30 and further includes receiving a UECS capability message indicating a capability of the UE for a joint radar processing.

Example 31 may be combined with any Examples 28-29 further include that the radar-transmitter is at least one of: a network entity, a UE within the UECS, or a UE outside the UECS.

Example 32 is an apparatus for wireless communication for implementing a method as in any of examples 1-31.

Example 33 is an apparatus for wireless communication including means for implementing a method as in any of examples 1-31.

Example 34 is a non-transitory computer-readable medium storing computer executable code, the code when executed by a processor causes the processor to implement a method as in any of examples 1-31.

What is claimed is:

1. A method of wireless communication at a coordinating user equipment (UE) of a user-equipment-coordination set (UECS) comprising:
receiving, from a first UE of the UECS, first object detection information for a first radar signal reception;
obtaining, from a second UE of the UECS, second object detection information for a second radar signal reception associated with a same transmitted radar signal as the first radar signal reception, the second object detection information being different than the first object detection information;
processing, at the coordinating UE, the first object detection information together with the second object detection information to produce joint object detection information; and
jointly transmitting, via the UECS, a radar report including joint object detection information of the UECS.

2. The method of claim 1, wherein the first object detection information comprises first in-phase and quadrature (IQ) samples of the first radar signal reception and the second object detection information comprises second IQ samples of the second radar signal reception.

3. The method of claim 2, wherein the first IQ samples are processed together with at least one of: the second IQ samples, location information of a radar-transmitter, location information of the first UE, or location information of the second UE, to generate the joint object detection information included in the radar report.

4. The method of claim 1, wherein the obtaining comprises:
receiving the second object detection information from the second UE, or generating the second object detection information by the coordinating UE.

5. The method of claim 1, wherein the first object detection information comprises at least one of:
a location of the first UE,
an antenna identification (ID) of the UE,
a beam ID of the UE,
IQ samples before orthogonal time-frequency space (OTFS) processing,
the IQ samples after the OTFS processing,
the IQ samples with partial OTFS processing,
the IQ samples before orthogonal frequency-division multiplexing (OFDM) processing,
the IQ samples after the OFDM processing, or
the IQ samples with partial OFDM processing.

6. The method of claim 1, further comprising:
receiving (210A), from a radar-transmitter (104), control signaling indicating a resource grant and a communication grant, the resource grant being for transmission of a radar signal between the radar-transmitter (104) and the UECS, the communication grant being for the transmitting (220B) the radar report.

7. The method of claim 1, further comprising:
communicating, with the first UE in the UECS, to identify sidelink parameters for at least one of: the receiving the first object detection information or the obtaining the second object detection information.

8. The method of claim 1, further comprising:
selecting, based on a UE capability message, the first UE and the second UE in the UECS to participate in joint radar processing.

9. The method of claim 1, further comprising:
transmitting, to a radar-transmitter, a UECS capability message indicating a capability of UEs in the UECS for joint radar processing.

10. The method of claim 9, further comprising:
selecting, based on a predetermined criterion, at least one UE in the UECS to participate in the joint radar processing, the predetermined criterion being at least one of a minimum radar range resolution or a minimum radar Doppler resolution.

11. The method of claim 1, wherein the jointly transmitting the radar report comprises:
sending the radar report to at least one of: a radar-transmitter, a network entity, the first UE within the UECS, or a UE outside the UECS.

12. A method of wireless communication at a first user equipment (UE) of a user-equipment-coordination set (UECS) comprising:
transmitting, to a coordinating UE of the UECS, first object detection information for a first radar signal reception;
receiving, from the coordinating UE, joint object detection information including the first object detection information processed together with second object detection information associated with a same transmitted radar signal as the first radar signal reception, the second object detection information being different than the first object detection information; and
jointly transmitting, via the UECS, a radar report including the joint object detection information.

13. The method of claim 12, wherein the first object detection information comprises in-phase and quadrature (IQ) samples of the first radar signal reception.

14. The method of claim 13, wherein the first object detection information comprises at least one of:
a location of the UE,
an antenna identification (ID) of the UE,
a beam ID of the UE,
the IQ samples before orthogonal time-frequency space (OTFS) processing,
the IQ samples after the OTFS processing,
the IQ samples with partial OTFS processed,
the IQ samples before orthogonal frequency-division multiplexing (OFDM) processing,
the IQ samples after the OFDM processing, or
the IQ samples with partial OFDM processing.

15. The method of claim 12, further comprising:
receiving, from the coordinating UE, a sidelink communication grant for the transmitting the first object detection information.

16. The method of claim 12, further comprising:
communicating, with the coordinating UE, to identify sidelink parameters for at least one of: the transmitting the first object detection information.

17. A method of wireless communication at a radar-transmitter comprising:
transmitting, to a user equipment (UE) in a user-equipment-coordination set (UECS), control signaling indicating a resource grant for a radar signal and a communication grant for a jointly-transmitted radar report;
transmitting, in conformance with the resource grant, the radar signal between the radar-transmitter and the UE in the UECS; and
receiving, from the UE in the UECS via the communication grant, the jointly-transmitted radar report including joint object detection information of the UECS, the joint object detection information corresponding to the transmitting of the radar signal.

18. The method of claim 17, wherein the receiving the jointly-transmitted radar report comprises at least one of:
receiving the jointly-transmitted radar report in a joint signal from multiple UEs in the UECS, or
receiving the jointly-transmitted radar report from one UE in the UECS.

19. The method of claim 17, further comprising:
receiving a UECS capability message indicating a capability of the UE for a joint radar processing.

20. The method of claim 17, wherein the radar-transmitter is at least one of: a network entity, a UE within the UECS, or a UE outside the UECS.
